(19) United States
(12) Patent Application Publication
(10) Pub. No.: US 2026/0244084 A1
(43) Pub. Date: Aug. 20, 2026

(54) 360 DEGREE VIEW CAMERA ASSEMBLY

(71) Applicant: Greg Stevens, Warren, MI (US)

(72) Inventor: Greg Stevens, Warren, MI (US)

(21) Appl. No.: 19/643,607

(22) Filed: Apr. 9, 2026

Related U.S. Application Data
(63) Continuation-in-part of application No. 19/245,807, filed on Jun. 23, 2025.
(60) Provisional application No. 63/662,758, filed on Jun. 21, 2024.

(51) Int. Cl. G03B 17/56; G03B 29/00; G03B 37/04; H04N 23/90

(52) U.S. Cl. CPC G03B 17/561; G03B 29/00; G03B 37/04; H04N 23/90

(57) ABSTRACT

A camera assembly for pole positioning includes two camera housings, each with a front and rear side. The first camera is attached to the front of the first housing, and the second camera is attached to the front of the second housing, both designed to capture 180-degree views. A first bracket is connected to the rear of the first housing, and a second bracket is connected to the rear of the second housing. These brackets can be joined around the pole, aligning the cameras opposite each other to create a 360-degree view.

### CROSS-REFERENCE TO RELATED APPLICATIONS

This utility patent application is a continuation-in-part of Ser. No. 19/245,807, filed on Jun. 23, 2025, which claims priority to U.S. Provisional Patent Application Ser. No. 63/662,758, filed on Jun. 21, 2024, and titled “360 Degree View Camera Assembly,” the entire disclosures of which are hereby incorporated by reference in their entireties.

### BACKGROUND OF THE DISCLOSURE

### 1. Field of the Disclosure

The present disclosure relates to camera assemblies, such as security camera assemblies.

### 2. Related Art

This section provides background information related to the present disclosure which is not necessarily prior art.

Security cameras have long been known in the art and have undergone significant advancements over the years, evolving from simple, stationary devices to sophisticated systems. The introduction of digital cameras marked a pivotal shift in the security camera industry, enhancing image quality, reducing costs, allowing cameras to be positioned at new locations using wireless connectivity, and allowing for remote monitoring and control through mobile applications. There remains a need for further developments to security cameras.

### SUMMARY OF THE DISCLOSURE

According to an aspect of the disclosure, a camera assembly for being positioned along a pole includes a first camera housing and a second camera housing each having a front side and a rear side. A first camera is coupled to the front side of the first camera housing and configured to record a 180 degree view. A second camera is coupled to the front side of the second camera housing and is configured to record a 180 degree view. A first bracket has a front surface coupled to the rear side of the first camera housing, and has a rear surface opposite the front surface. A second bracket has a front surface coupled to the rear side of the second camera housing, and has a rear surface opposite the front surface. The rear surfaces of the first and second brackets are connectable to one another about the pole such that the first and second cameras are oriented opposite one another to generate a 360 degree view.

According to another aspect of the disclosure, a method for assembling a camera assembly includes providing a first camera housing and a second camera housing each having a front side and a rear side, with a first camera coupled to the front side of the first camera housing and a second camera coupled to the front side of the second camera housing. Each of the first and second cameras are configured to record a 180 degree view. The method also includes providing a first bracket and a second bracket, where each of the first and second brackets have a front surface and a rear surface opposite the front side. The method also includes coupling the front surface of the first bracket to the rear side of the first camera housing. The method also includes coupling the front surface of the second bracket to the rear side of the second camera housing. The method also includes positioning the rear surfaces of the first and second brackets against each other about the pole, and coupling the first and second brackets to one another to fix the first and second brackets to the pole and to permit the first and second cameras to generate a 360 degree view together.

The brackets of the subject camera assembly and associated method permit two 180 degree view cameras to easily be connected to one another on opposite sides of a pole, e.g., light poles and signs, to provide a 360 degree view. The embodiments of the camera assembly are also simple in design and inexpensive to manufacture.

### BRIEF DESCRIPTION OF THE DRAWINGS

These and other aspects of the present disclosure will be more readily understood by reference to the following description in combination with the accompanying drawings wherein:

FIG. 1A is a perspective view of a first embodiment of a camera assembly according to an aspect of the disclosure, illustrating the camera assembly connected to a pole of a light assembly;

FIG. 1B is a magnified perspective view of the first embodiment of the camera assembly;

FIG. 1C is a top, schematic view of the first embodiment of the camera assembly, illustrating a first arrangement of a connecting mechanism;

FIG. 1D is a top, schematic view of the first embodiment of the camera assembly, illustrating a second arrangement of a connecting mechanism;

FIG. 2A is a perspective view of a second embodiment of a camera assembly, illustrating the camera assembly mounted to a pole of a light assembly;

FIG. 2B is a magnified perspective view of the second embodiment of the camera assembly;

FIG. 3 is a perspective view of a third embodiment of a camera assembly, illustrating the camera assembly connected to a pole;

FIG. 4 is a front, perspective view of two cameras of the third embodiment of the camera assembly;

FIG. 5 is a front, perspective view of a first bracket of the third embodiment of the camera assembly;

FIG. 6 is a rear, perspective view of the first bracket of the third embodiment of the camera assembly; and

FIG. 7 is a flow diagram of a method for assembling the third embodiment of the camera assembly.

### DETAILED DESCRIPTION OF THE ENABLING EMBODIMENTS

Example embodiments will now be described more fully with reference to the accompanying drawings. In general, the subject embodiments are directed to a security camera assembly. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the figures, wherein like numerals indicate corresponding parts throughout the several views, embodiments of a security camera assembly 20, 120 are provided. The security camera assembly 20, 120 includes an arrangement of cameras 22, 122 that are configured to be positioned 360 degrees around a center axis A along a pole 24, 124 to permit the cameras 22, 122 to record footage 360 degrees around the pole 24, 124. The embodiments of the security camera assembly 20, 120 may be connected to the pole 24, 124 in a simple and efficient manner. The security camera assembly 10, 120 may be connected to various types of poles 24, 124, such as light poles or signs. Any number of cameras 22, 122 may be used and they may be spaced from each other at various distances. Various types of cameras 22, 122 may be used, such as digital and film cameras. The cameras 22, 122 may be configured to record still images as well as video footage.

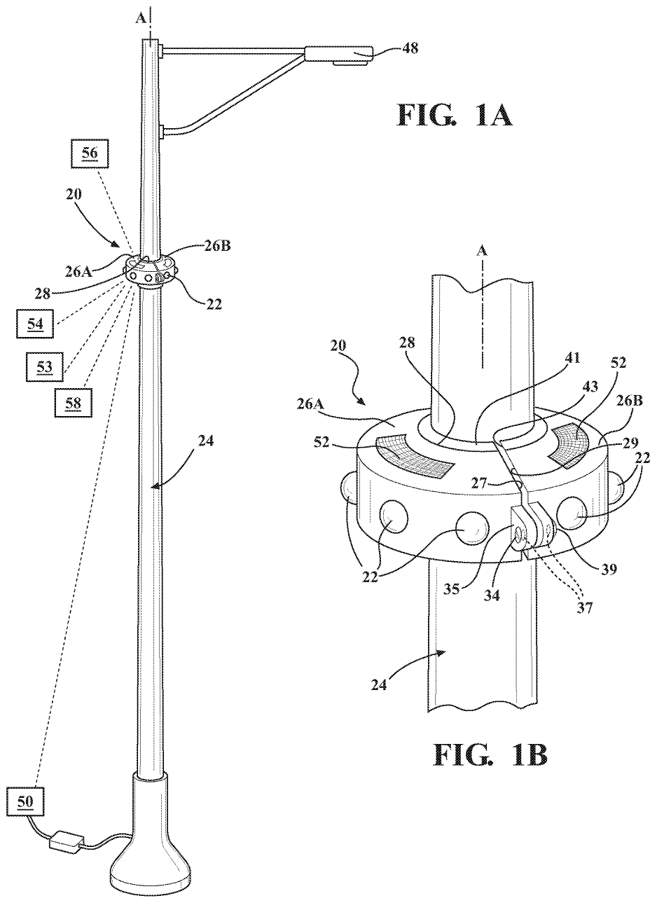

With reference to FIGS. 1A-1C, a first embodiment of the security camera assembly 20 is a two-piece assembly which may easily be positioned about, and connected to a single-piece pole 24. The assembly 20 includes a generally disc-shaped camera housing 26A, 26B. The camera housing 26A, 26B holds a plurality of the cameras 22, e.g., six, in circumferentially spaced relationship with one another and pointed radially outwardly from the axis A for providing a 360 degree view around the camera assembly 20. The camera housing 26A, 26B defines an opening 28 along the center axis A for receiving the pole 24, with an inside surface of the camera housing 26 in the opening 28 engaging the pole 24. Once the camera assembly 26 is connected, the center axis A extends along a longitudinal length of the pole 24.

The camera housing 26A, 26B may be separated into a first segment 26A and a second segment 26B that are detachably connectable to one another and configured to be compressed toward one another against the pole 24 to secure the camera housing 26A, 26B to the pole 24. The first segment 26A terminates at a pair of first ends 27, and the second segment 26B terminates at a pair of second ends 29. According to the shown embodiment, the first ends 27 extend along a first plane and the second ends 29 extend along a second plane, and when the first and second segments 26A, 26B are connected to one another, the ends 27, 29 of the first and second segments 26A, 26B lie flush over one another substantially along a common plane. A connecting mechanism 33A, 33B is configured to detachably connect the first and second segments 30, 32 of the camera housing 26 to the pole 24 and to tighten the first and second segments 26A, 26B against the pole 24 to fix the camera assembly 20 in place.

As best shown in FIGS. 1B and 1C, a first arrangement of the connecting mechanism 33A includes two or more flanges 35 that each extend outwardly from one of the segments 26A, 26B of the housing 26A, 26B and are configured to be aligned with one another when the segments 26A, 26B are positioned about the pole 24. The flanges 35 may define orifices 37 to receive the bolts 34. A nut 39 may be threaded to an end of the bolt 34 to secure the bolt in place. As shown in FIG. 1C, the connecting mechanism 33A may include an arrangement of two flanges 35 and one bolt 34 on opposing circumferential sides of the housing 26A, 26B.

As shown in FIG. 1D, according to another arrangement of the connecting mechanism, 33B, the segments 26A, 26B of the housing 26A, 26B may be pivotally connected to each other at a pivoting mechanism 31 along one side of the housing 26A, 26B, and an arrangement of flanges 35 and a bolt 34 may be located on an opposite side to permit the housing 26A, 26B to be pivotally opened to clamp around the pole 24. Other types of connecting mechanisms may be utilized such as latches, hook and loop connectors, etc. Furthermore, a biasing mechanism 25, like a spring, may bias the segments toward one another 26A, 26B against the pole 24.

The assembly 20 may be connected to poles 24 of various sizes, e.g., a 6 or 8 inch diameter. A bushing 41 may be positioned along the opening 28 to allow the assembly 20A to be coupled with more narrow poles 24. The bushing 41 may have various thicknesses to accommodate poles 24 of different sizes. The bushing 41 may have a slot 43 to allow the bushing to be elastically opened and positioned about the pole 24.

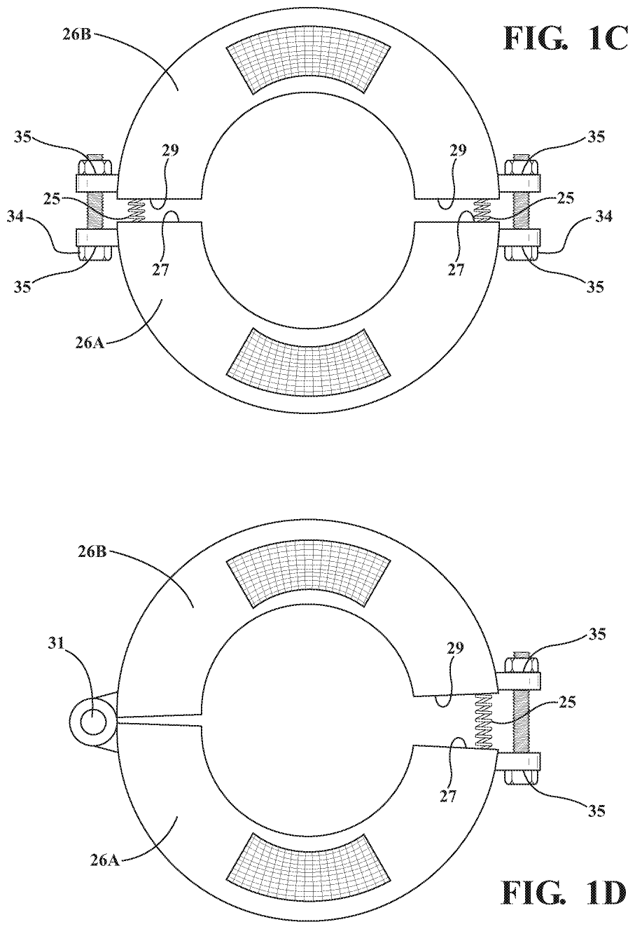

A second embodiment of the security camera assembly 120 is shown in FIG. 2A-2B. This embodiment is configured as a one-piece assembly, which requires no assembly of components of the camera assembly 120 relative to one another. The camera assembly 120 has a camera housing 126 which holds a plurality of cameras 122 positioned in circumferentially spaced relationship with one another and pointed radially outwardly from the axis A for providing a 360 degree view around the camera assembly 120. The camera housing 126 has an upper surface 136 and a lower surface 138.

A lower sleeve 140 is connected to the lower surface 138 of the camera housing 126 and extends downwardly from the camera housing 126 along the center axis A. The lower sleeve 140 is configured to receive top of a lower segment 142 of the pole 124 in a lower opening 145 of the sleeve 140 to connect the camera housing 126 to the lower segment 142 of the pole 124. Alternatively, the lower sleeve 140 may be received in an opening of the lower segment 142 of the pole 124. An upper sleeve 144 is connected to the upper surface 136 of the camera housing 126 and extends upwardly from the camera housing 126. The upper sleeve 144 is configured to receive an upper segment 146 of the pole 124 in an upper opening 147 to connect the camera housing 126 to the upper segment 146. Alternatively, the upper sleeve 144 may be received in an opening of the upper segment 146 of the pole 124. Accordingly, the camera housing 126 is sandwiched between the lower and upper segments 142, 146 of the pole 124. As an alternative, the upper and lower sleeves 140, 144 may be a single, one-piece component that extends through the camera housing 126. Wires associated with features of the pole 24, like a light assembly, may pass through the camera assembly 20.

A bushing 141 may be positioned in one or more of the upper and lower sleeves 140, 144 to allow the assembly 120 to be coupled with more narrow poles 124. Again, the bushing 141 may have various thicknesses to accommodate poles 124 of different sizes. The bushing 141 may have a slot 143 to allow the bushing 141 to be elastically opened and positioned about the pole 124

As schematically shown in FIGS. 1A and 2A, both embodiments of the camera assembly 20, 120 are connected to a power source 50 for powering the cameras 22, 122 of the camera housing 26A, 26B, 126. The power source 50 may include various types of power sources, including batteries or a mains electricity source. The power source 50 may be positioned in a compartment of the camera housing 26A, 26B, 126, such as when the power source 50 is comprised of batteries. One or more solar panels 52 may be positioned on top of the camera housing 26 for charging the power source 50. Alternatively, one or more power lines 54 may electrically connect the cameras 22 to the power source 50, such as when a mains electricity source is used. The power line 54 may extend through the lower pole or along a sidewall of the lower pole inside or independent of a conduit.

The security camera assembly 20A, 20B may also include a controller 53 and wireless communication device 56 for permitting the security camera assembly 20A, 20B to be controlled, and to established wireless communication with other devices, e.g., cloud based networks, mobile devices and personal computers. The wireless connection may permit footage to be viewed and externally saved, and may also permit operators to modify the cameras 22, e.g., change a field of vision, or orient the cameras 22 in desired directions. The controller 53 may also have an internal hard drive 58 for locally saving footage.

As shown, a light assembly 48 may be connected to the upper segment 46 of the pole 24 in the event that the pole 24 is part of a light assembly. Other features may be connected to the upper segment 46 of the pole 24, e.g., a sign.

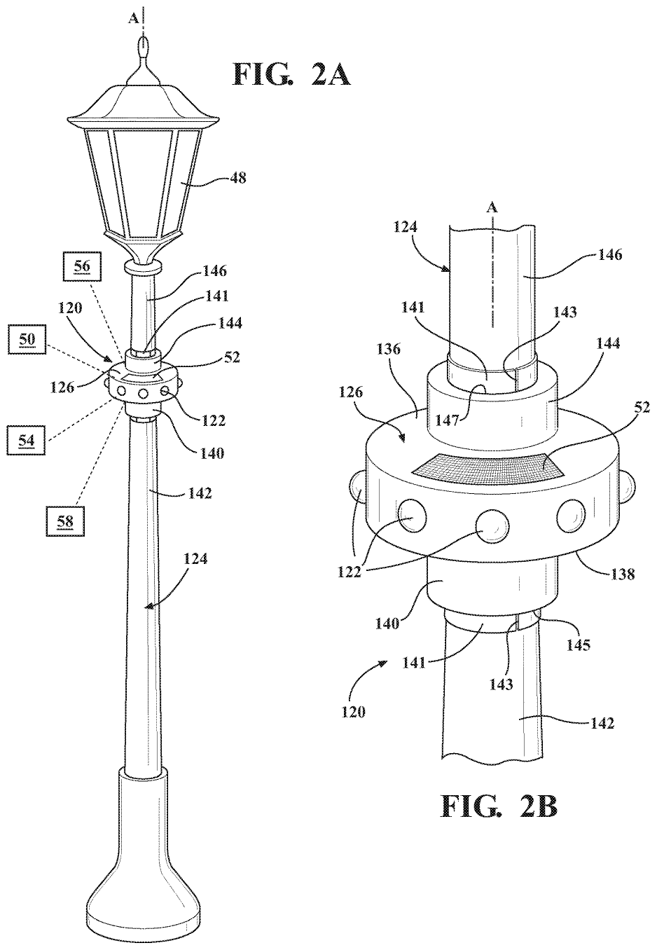

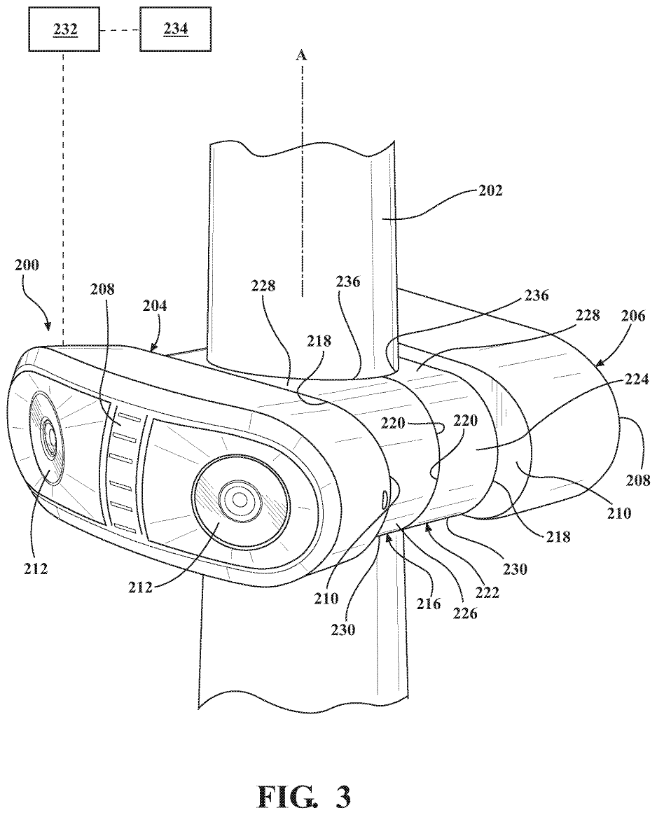

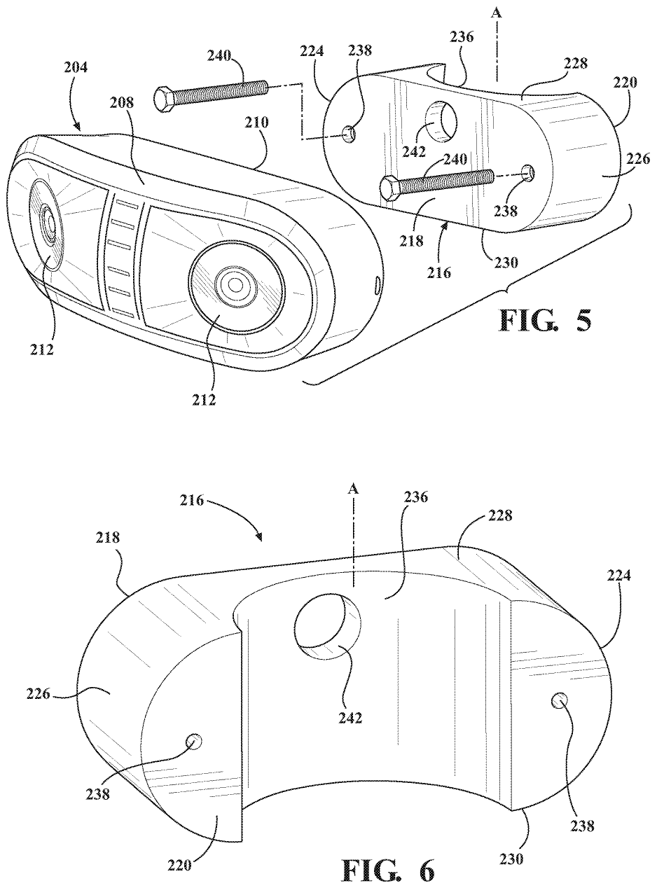

A third embodiment of a camera assembly 200 for being positioned along a pole 202 is shown in FIGS. 3-7. The camera assembly 200 includes a first camera housing 204 and a second camera housing 206 that each have a front side 208 and a rear side 210. A pair of first cameras 212 are coupled to the front side 208 of the first camera housing 204 and are configured to record a 180 degree view. A pair of second cameras 214 are coupled to the front side 208 of the second camera housing 206 and is configured to record a 180 degree view.

A first bracket 216 is coupled to the rear side 210 of the first camera housing 204. The first bracket 216 has a front surface 218 coupled to the rear side 210 of the first camera housing 204, and has a rear surface 220 opposite the front surface 218. Likewise, a second bracket 222 is coupled to the rear side 210 of the second camera housing 206. The second bracket 222 has a front surface 218 coupled to the rear side 210 of the second camera housing 206, and has a rear surface 220 opposite the front surface 218. The first and second brackets 216, 222 each further have a left surface 224, a right surface 226 opposite the left surface 224, a top surface 228 and a bottom surface 230. The left and right surfaces 224, 226 of each of the first and second brackets 216, 222 each have a convex shape. The top and bottom surfaces 228, 230 of each of the first and second brackets 216, 222 are substantially planar.

As best shown in FIG. 3, the rear surfaces 220 of the first and second brackets 216, 222 are connectable to one another about the pole 202 such that the first and second cameras 212, 214 are oriented opposite one another. A controller 232 is electronically connected to the first and second cameras 212, 214 and configured to stitch together the views from the first and second cameras 212, 214 to generate a 360 degree view. The camera assembly 200 also has at least one display 234 that is electrically connected to the controller 232 and first and second cameras 212, 214 and configured to present the at least one 360 degree view from the first and second cameras 212, 214. Various types of displays 234 may be used, including but not limited to, the screens of a computer, smartphone, tablet, etc.

The rear surface 220 of each of the first and second brackets 216, 222 defines a concave shaped recess 236 that is configured to receive the pole 202. The recesses 236 are aligned with one another about the pole 202 when the first and second brackets 216, 222 are coupled to one another. The recesses 236 of each of the first and second brackets 216, 222 extend along a center axis A extending vertically halfway between the left and right surfaces 224, 226.

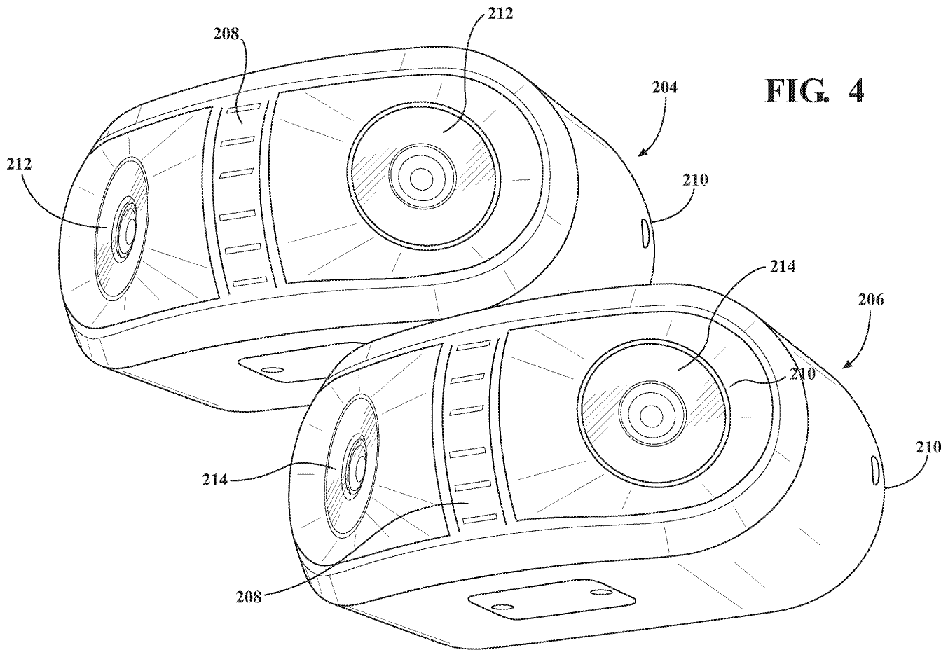

The rear surface 226 of each of the first and second brackets 216, 222 defines a pair of connecting passages 238 on opposite sides of the recess 236 for receiving fasteners 240 to couple the first and second brackets 216, 222 to one another about the pole 202. Each of the first and second brackets 216, 222 also defines a central orifice 242 along the recess 236 for receiving connecting components of the first and second cameras 212, 214, as shown in FIG. 5. The connecting components may include connection and power cables, which may extend into the pole 202 for connection to a power source, controller, etc.

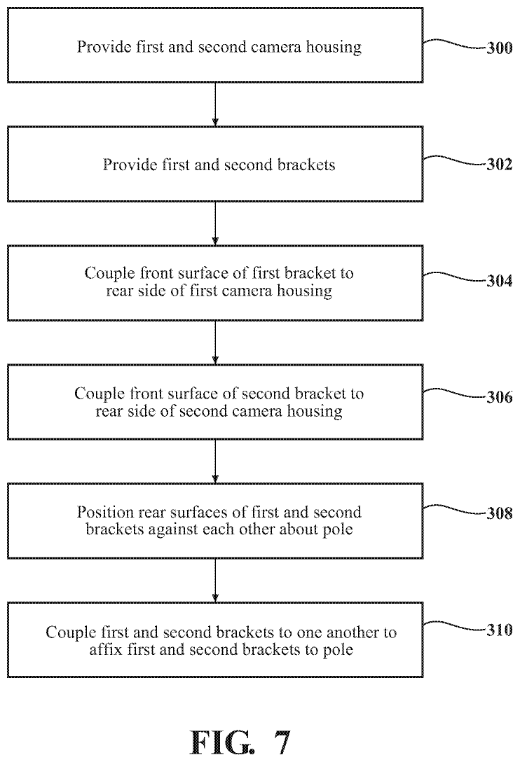

As shown in FIG. 7, a method for assembling a camera assembly 200 is also provided. The method includes 300 providing a first camera housing 204 and a second camera housing 206 as discussed above. The method also includes 302 providing a first bracket 216 and a second bracket 222. The method also includes 304 coupling the front surface 218 of the first bracket 216 to the rear side 210 of the first camera housing 204. The method also includes 306 coupling the front surface 218 of the second bracket 222 to the rear side 210 of the second camera housing 206. The method also includes 308 positioning the rear surfaces 220 of the first and second brackets 216, 222 against each other about the pole 202, and 310 coupling the first and second brackets 216, 222 to one another to fix the first and second brackets 216, 222 to the pole 202 to permit the first and second cameras 212, 214 to generate a 360 degree view together.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A camera assembly for being positioned along a pole, comprising:
a first camera housing and a second camera housing each having a front side and a rear side;
a first camera coupled to the front side of the first camera housing and configured to record a 180 degree view;
a second camera coupled to the front side of the second camera housing and configured to record a 180 degree view;
a first bracket having a front surface coupled to the rear side of the first camera housing, and having a rear surface opposite the front surface;
a second bracket having a front surface coupled to the rear side of the second camera housing, and having a rear surface opposite the front surface; and
the rear surfaces of the first and second brackets connectable to one another about the pole such that the first and second cameras are oriented opposite one another to generate a 360 degree view.

2. The camera assembly as set forth in claim 1, further including a controller electronically connected to the first and second cameras and configured to stitch together the views from the first and second cameras to generate the 360 degree view.

3. The camera assembly as set forth in claim 2, further including at least one display configured to present the at least one 360 degree view from the first and second cameras.

4. The camera assembly as set forth in claim 1, wherein the rear surface of each of the first and second brackets defines a concave shaped recess configured to receive the pole, with the recesses aligned with one another about the pole when the first and second brackets are coupled to one another.

5. The camera assembly as set forth in claim 4, wherein the first and second brackets each further have a left surface, a right surface opposite the left surface, a top surface and a bottom surface.

6. The camera assembly as set forth in claim 5, wherein the left and right surfaces of each of the first and second brackets each have a convex shape.

7. The camera assembly as set forth in claim 5, wherein the recesses of each of the first and second brackets extend along a center axis extending vertically halfway between the left and right surfaces.

8. The camera assembly as set forth in claim 7, wherein the rear surface of each of the first and second brackets defines a pair of connecting passages on opposite sides of the recess for receiving fasteners to couple the first and second brackets to one another.

9. The camera assembly as set forth in claim 5, wherein the top and bottom surfaces of each of the first and second brackets are substantially planar.

10. The camera assembly as set forth in claim 4, wherein each of the first and second brackets defines a central orifice along the recess for receiving connecting components of the first and second cameras.

11. A method for assembling a camera assembly, comprising:
providing a first camera housing and a second camera housing each having a front side and a rear side, with a first camera coupled to the front side of the first camera housing and a second camera coupled to the front side of the second camera housing, wherein each of the first and second cameras are configured to record a 180 degree view;
providing a first bracket and a second bracket, where each of the first and second brackets have a front surface and a rear surface opposite the front surface;
coupling the front surface of the first bracket to the rear side of the first camera housing;
coupling the front surface of the second bracket to the rear side of the second camera housing; and
positioning the rear surfaces of the first and second brackets against each other about the pole, and coupling the first and second brackets to one another to fix the first and second brackets to the pole and to permit the first and second cameras to generate a 360 degree view together.

12. The method as set forth in claim 11, further including stitching together 180 degree views from the first and second cameras to create the 360 degree view with a controller.

13. The method as set forth in claim 12, further including displaying the 360 degree view generated by the controller on at least one display.

14. The method as set forth in claim 11, wherein the rear surface of each of the first and second brackets defines a concave shaped recess configured to receive the pole, and wherein the method further includes aligning the recesses aligned with one another about the pole when the first and second brackets are coupled to one another such that the recesses together have a circle shape around the pole.

15. The method as set forth in claim 14, wherein the first and second brackets each further have a left surface, a right surface opposite the left surface, a top surface and a bottom surface.

16. The method as set forth in claim 15, wherein the left and right surfaces of each of the first and second brackets each have a convex shape.

17. The method as set forth in claim 14, wherein the recesses of each of the first and second brackets extend along a center axis extending vertically halfway between the left and right surfaces.

18. The method as set forth in claim 17, wherein the rear surface of each of the first and second brackets defines a pair of connecting passages on opposite sides of the recess, and wherein the method further includes extending fasteners through the connecting passages of the first and second brackets to couple the first and second brackets to one another.

19. The method as set forth in claim 15, wherein the top and bottom surfaces of each of the first and second brackets are substantially planar.

20. The method as set forth in claim 14, wherein each of the first and second brackets defines a central orifice along the recess for receiving connecting components of the first and second cameras.
